(19) United States
(12) Patent Application Publication
(10) Pub. No.: US 2026/0185684 A1
(43) Pub. Date: Jul. 2, 2026

(54) Commercial Light Fixtures Using Sustainable Materials and Related Methods

(71) Applicant: RAB Lighting Inc., New York, NY (US)

(72) Inventors: Glen OROSS, Heber City, UT (US); Peter ON, Henderson, NV (US); Jose QUINONES, Pearland, TX (US); Frederic B. HODSHON, Redmond, WA (US); Emma Fife, Salt Lake City, UT (US); Kenric Garrison, Wellington, OH (US); Nicholas Calaceto, Paramus, NJ (US); Ross A. BARNA, NEW YORK, NY (US); Stephen OSBORNE, GLEN ARM, MD (US)

(21) Appl. No.: 19/004,320

(22) Filed: Dec. 28, 2024

(51) Int. Cl. F21V 15/01; F21V 17/00; F21V 17/10; F21V 25/12

(52) U.S. Cl. CPC F21V 15/01; F21V 17/005; F21V 17/105; F21V 25/12

(57) ABSTRACT

A light fixture includes an inner housing made from flame-resistant material to contain high-voltage components and optionally provide structural support. An outer housing encloses the inner housing and includes an optical component and components formed from sustainable materials, which are either recycled, recyclable, bio-degradable, or bio-renewable. The fixture's design ensures compliance with industry safety standards for flame resistance and high voltage. The sustainable materials used in the outer housing contribute significantly to the fixture's total weight, promoting environmental responsibility and sustainability within the commercial lighting industry.

### TECHNICAL FIELD

The present disclosure relates to a commercial light fixture design, and more particularly, to a light fixture that incorporates sustainable materials while maintaining safety and material integrity standards.

### BACKGROUND

In recent years, there has been a growing emphasis on sustainability across various industries, including the lighting industry. The environmental impact of traditional light fixtures, which often rely on non-renewable materials and contribute to waste, energy-intensive manufacturing processes, fossil-based material use, and carbon and greenhouse gas emissions has prompted a shift towards more sustainable practices. This shift is driven by ethical consideration, regulatory pressures, and consumer demand for eco-friendly products. As a result, manufacturers must consider the use of sustainable materials in the design and production of light fixtures, yet for the commercial lighting industry material choices continue to be largely based only on functionality, material integrity, cost, and aesthetic requirements.

Sustainable materials encompass a wide range of eco-friendly options that are used to minimize environmental impact, but many of the presently available options are not suitable for commercial lighting applications. Sustainable materials are defined to be materials formed from components that are at least one of bio-renewable and bio-degradable, or from non-metallic components that are at least one of recycled and recyclable. However, many known sustainable materials generally lack the functionality, material integrity, cost, and/or aesthetics needed for commercial light fixtures, including most sustainable materials that are 100% bio-renewable; therefore, sustainable materials are not simple substitutes that can be swapped out for components of existing commercial light fixture designs. Material integrity required in commercial light fixtures includes rigidity, hardness and impact resistance, humidity resistance, heat resistance, UV resistance, mold resistance, flame resistance, and durability.

Available sustainable material components include natural polymers that are bio-based and bio-renewable substances and textiles such as felt, hemp, paper pulp, cellulose, and calcium carbonate sourced from shells. Additionally, recycled material components such as recycled synthetic polymers can reduce further dependence on non-renewable resources.

Commercial light fixtures, in particular, present unique challenges and opportunities in the pursuit of incorporating sustainable materials. These fixtures must not only meet aesthetic and functional requirements but also adhere to stringent industry safety standards, including for example UL 8750 for LED light fixture. Therefore, the integration of sustainable materials into commercial light fixtures requires innovative design approaches to ensure that these materials do not compromise the fixture's performance, safety, and other design criteria. Additionally, installing prior art commercial light fixtures typically requires removing the lens and, in some case, moving the light source to gain access for mounting the fixture to a surface such as a ceiling and for wiring the power supply to AC supply wires. Additionally, the need to enclose high voltage components and power supplies in a manner that is both safe and environmentally friendly adds another layer of complexity to the design process. Therefore, there is a pressing need for solutions that effectively balance sustainability with the technical, regulatory, aesthetic, and cost demands of commercial lighting applications.

### SUMMARY

A light fixture includes an inner housing made from flame-resistant material to contain high-voltage components and optionally provide structural support. An outer housing encloses the inner housing and includes an optical component and components formed from sustainable materials, which are either recycled, recyclable, bio-degradable, or bio-renewable. The fixture's design ensures compliance with industry safety standards for flame resistance and high voltage. The sustainable materials used in the outer housing contribute significantly to the fixture's total weight, promoting environmental responsibility and sustainability within the commercial lighting industry.

This disclosure provides a light fixture that may include an inner housing and an outer housing. The inner housing can be configured to contain high-voltage components and form a structural framework for the light fixture, ensuring compliance with industry safety standards such as flame-resistance. This inner housing may be formed from a flame-resistant material, such as rigid sheet metal, to provide durability and structural support. The outer housing can enclose the inner housing and may consist of an optical component and components formed from sustainable materials. These sustainable materials may include recycled, recyclable, bio-degradable, and bio-renewable components, promoting environmental sustainability. The outer housing can also provide optical functionality and an aesthetically pleasing appearance. The light fixture may maximize the use of sustainable materials, replacing portions of traditional fixture materials to reduce the environmental impact of production and end-of-life while still meeting safety and material integrity requirements. The design may include features such as a living hinge to enable opening and closing functionality to access an interior of the inner housing and facilitate installation and decommissioning.

The inner housing is configured to contain high-voltage components and form a structural framework for the light fixture. This configuration may be achieved by forming the inner housing from a flame-resistant material, which may include a rigid material such as sheet metal. The use of a metal inner housing provides safety and structural support, as contains a power supply device such as an LED driver and optional emergency backup battery and may contain high voltage connections from supply power. The inner housing serving as a structural chassis for the light fixture supports the outer housing and facilitates the mounting of the light fixture. The design complies with industry safety standards, such as UL 8750, ensuring flame-resistance and safety for high-voltage components.

The outer housing encloses the inner housing. “Enclose” and “enclosure” are understood to mean that a housing or enclosure fully encompasses an interior space while not necessarily offering a complete seal, for example, from water ingress, and any openings therethrough are limited to those required for the passage of electrical wires, fasteners, conduit, access closures, and mounting hardware. This outer housing may also enclose the light source, which can ensure the protection of components and promote sustainability. The outer housing may consist of an optical component and components formed from sustainable material, which may include at least one component that is recycled and recyclable and at least one component that is bio-degradable and bio-renewable. The optical component may be formed from an optical quality material that may or may not be a sustainable material. For example, the optical component may be formed from optical quality materials like polycarbonate, polymethyl methacrylate, polypropylene, or glass, all of which may be recycled and/or recyclable.

The outer housing components formed from sustainable material may include a cover and end caps. The cover may have features like bosses for spacing and attachment, ribs for shape retention and spacing, and protrusions for retention and/or alignment with the inner housing. The light fixture can also include a hinge connecting the upper and lower housing parts. The integration of these features into a commercial light fixture promotes sustainability by minimizing the use of non-sustainable materials and maintaining an aesthetically pleasing appearance as design criteria. This configuration also promotes environmental sustainability and reduce the environmental impact.

The outer housing components formed from sustainable materials and the inner housing formed from recycled and recyclable material may comprise at least 50% of the total weight of the light fixture in one embodiment, at least 60% of the total weight of the light fixture in another embodiment, at least 68% of the total weight of the light fixture in yet another embodiment, and at least 85% of the total weight of the light fixture in another embodiment. This composition may ensure significant use of sustainable materials, reducing the environmental impact of production and decommissioning while meeting industry safety standards and other design criteria discussed herein. The outer housing components may include materials such as virgin or recycled thermoplastic, felt material, natural textiles, recycled PET plastic bottles, and bio-renewable materials like hemp, paper pulp, cellulose, and calcium carbonate sourced from waste shells. The sustainable materials used in the outer housing may comprise a significant portion of the total weight of the light fixture, ensuring a substantial use of sustainable materials. Additionally, the total size and weight of the light fixture may be reduced by optimizing the power and optical components to reduce the amount of non-sustainable and sustainable material required to house the power supply, light source, and optical component.

In the context of the light fixture system, the coupling of one side of an upper housing and a lower housing may be facilitated by a hinge, for example, a living hinge formed from a recycled, recyclable, bio-renewable, and/or bio-degradable material. This configuration may facilitate assembly, installation, decommissioning, and structural integrity, allowing for a seamless integration of the upper and lower housings. The hinge may also include alignment features, such as a tongue and groove joint, which can ensure proper alignment and secure attachment of the housing components. The use of a hinge in this manner may allow for easy access to the interior components of the light fixture, such as the power supply and an upper portion of the inner housing for installation and decommissioning. The hinge may be complemented by other components, such as a spring clip or a magnet, which can releasably retain the lower housing in a closed position relative to the upper housing. This configuration may provide a secure and reliable closure mechanism that can be operated without tools yet ensuring that the light fixture remains intact during operation. The integration of these components may contribute to the overall efficiency and effectiveness of the light fixture system.

The light fixture may include an inner housing designed to hold high-voltage components and provide a structural framework, which can be made from flame-resistant material that can be rigid, for example, recycled sheet metal. The fixture can also have an outer housing that encloses the inner housing, consisting of an optical component and parts made from sustainable materials, which may include recycled, recyclable, bio-degradable, and bio-renewable components. The sustainable material can be composed of less than 76% recyclable material and at least 24% bio-renewable material. The composition may include about 70% synthetic polymer, about 26% bio-renewable filler, and about 4% natural pigment. In some cases, the sustainable material is formed from a single component that may be bio-renewable. The synthetic polymer used in some examples can be a recycled thermoplastic material. The bio-renewable filler composition may include about 11.5% cellulose and about 88.5% calcium carbonate, or about 20% cellulose and about 80% calcium carbonate.

A light fixture includes an inner housing configured to contain high-voltage components and form a structural framework for the light fixture, wherein the inner housing is formed from a flame-resistant material; and an outer housing enclosing the inner housing, wherein the outer housing consists of an optical component and components formed from sustainable material that includes component that is at least one of recycled and recyclable and at least one component that is at least one of bio-degradable and bio-renewable. In one case the at least one component that is at least one of recycled and recyclable is recycled and the at least one component that is at least one of bio-degradable and bio-renewable is bio-renewable. The flame-resistant material forming the inner housing can be a rigid metal. The sustainable material can comprise at least one of bio-renewable fillers, natural textiles, biomass sourced textiles, and biopolymers. The at least one component that is at least one of recycled and recyclable and the at least one component that is at least one of bio-degradable and bio-renewable can be the same component.

In one embodiment the sustainable material is formed from a composition comprising less than 76% recyclable material and at least 24% bio-renewable material. The sustainable material can comprise about 70% synthetic polymer, about 26% bio-renewable filler, and about 4% natural pigment. The synthetic polymer can be a recycled thermoplastic material. The bio-renewable filler composition can comprise about 11.5% cellulose and about 88.5% calcium carbonate. The bio-renewable filler composition can comprise about 20% cellulose and about 80% calcium carbonate. The optical component can include at least one of a lens and a diffuser formed from one of polycarbonate, polymethyl methacrylate, polypropylene, and glass. The outer housing components formed from the sustainable material can comprise a cover and a plurality of end caps. The cover can define bosses configured for spacing and attachment of the cover to the inner housing, ribs configured for shape retention, and protrusions configured for retaining portions of the cover in alignment with the inner housing.

The light fixture can further comprise a hinge coupling one side of an upper housing and a lower housing of the light fixture. The hinge can be a living hinge and includes alignment features defined on opposite leaves of the hinge. The alignment features can form a tongue and groove joint. A barrel portion of the hinge can define a substantially thinner wall thickness than a wall thickness of the leaves of the hinge. The hinge can define ribs extending between the barrel portion and the alignment features. The light fixture can further comprise at least one of a spring clip and a magnet for releasably retaining the lower housing in a closed position relative to the upper housing.

The upper housing can include a top portion of the inner housing and the lower housing includes a bottom portion of the inner housing. The upper housing can include a cover, top end caps, at least one power supply, and a top portion of the inner housing. The lower housing can include an optical subassembly including a lens, lower end caps, a combined light emitter tray and lens frame forming a bottom portion of the inner housing, and light emitter boards coupled to a bottom side of the bottom portion of the inner housing.

The inner housing can be configured to enable the light fixture to meet flame-resistance and high voltage industry safety standards. The inner housing can be configured to support the outer housing and defines attachment features for mounting the light fixture. The inner housing can define between the inner housing and the outer housing at least one wire channel for routing wires through, thereby limiting visibility of and access to the wires from the space between a top portion and a bottom portion of the inner housing. Any openings defined through the inner housing adjacent exposed high voltage terminals and connections can have a minimum diameter of less than 12 millimeters.

The outer housing components formed from sustainable materials can comprise at least 10% of the total weight of the light fixture. The outer housing components formed from sustainable materials can comprise at least 40% of the total weight of the outer housing components. The flame-resistant material forming the inner housing and the sustainable material components of the outer housing can comprise at least 50% of the total weight of the light fixture. The flame-resistant material forming the inner housing and the sustainable material components of the outer housing can comprise at least 60% of the total weight of the light fixture. The flame-resistant material forming the inner housing and the sustainable material components of the outer housing can comprise at least 68% of the total weight of the light fixture. The flame-resistant material forming the inner housing and the sustainable material components of the outer housing can comprise at least 85% of the total weight of the light fixture.

Another illustrative embodiment of the light fixture can comprising an inner housing configured to contain high-voltage components, wherein the inner housing is formed from a flame-resistant material; and an outer housing enclosing the inner housing, wherein the outer housing consists of an optical component, and components formed from sustainable material that includes at least one component that is at least one of bio-degradable and bio-renewable. The flame-resistant material can be rigid; and the inner housing can form a structural framework for the light fixture.

The flame-resistant material forming the inner housing and the sustainable material components of the outer housing can comprise at least 50% of the total weight of the light fixture, or alternatively can comprise at least 60% of the total weight of the light fixture, or alternatively can comprise at least 68% of the total weight of the light fixture, or alternatively can comprise at least 85% of the total weight of the light fixture.

The sustainable material can further include at least one component that is at least one of recycled and recyclable. The at least one component that is at least one of recycled and recyclable can be recycled. The at least one component that is at least one of bio-degradable and bio-renewable can be bio-renewable. The at least one component that is at least one of recycled and recyclable can be recycled; and the at least one component that is at least one of bio-degradable and bio-renewable can be bio-renewable. The sustainable material formed from a composition can comprising less than 76% recyclable material and at least 24% bio-renewable material. The sustainable material can comprise about 70% recycled thermoplastic, about 26% bio-renewable filler, and about 4% natural pigment.

A method of manufacturing a light fixture comprises forming an inner housing from flame-resistant material to contain high-voltage components and provide a structural framework for the light fixture; and forming an outer housing for enclosing the inner housing, the outer housing consisting of an optical component, and components formed from sustainable material that includes at least one component that at least one of recycled and recyclable and at least one component that is at least one of bio-degradable and bio-renewable. The optical component may be formed from an optical quality material that may or may not be a sustainable material.

Forming the outer housing can include selecting a sustainable material composition comprising at least one of bio-renewable fillers, natural textiles, biomass sourced textiles, and biopolymers. Forming the outer housing can include selecting a sustainable material composition comprising at least one of bio-renewable fillers, natural textiles, biomass sourced textiles, and biopolymers.

Forming the outer housing can include selecting a sustainable material composition comprising less than 76% recyclable material and at least 24% bio-renewable material. Forming the outer housing can include selecting a sustainable material composition comprising about 70% synthetic polymer, about 26% bio-renewable filler, and about 4% natural pigment. The synthetic polymer is selected from a recycled thermoplastic material. The bio-renewable filler can be selected as about 11.5% cellulose and about 88.5% calcium carbonate. The bio-renewable filler can be selected as about 20% cellulose and about 80% calcium carbonate. Forming the inner housing can include selecting the flame-resistant material and configuring the inner housing and outer housing to enable the light fixture to meet flame-resistance and high voltage industry safety standards. Forming the inner housing comprises forming the inner housing from rigid sheet metal.

The method of manufacturing can further comprise providing a living hinge attaching one edge of a top portion of the inner housing and a bottom portion of the inner housing and providing a fastener for releasably attaching the other edge of the top portion of the inner housing and the bottom portion of the inner housing. The method can further comprise mounting at least one power supply to a bottom side of the top portion of the inner housing and mounting at least one light emitter to a bottom side of the bottom portion of the inner housing. The outer housing components formed from sustainable materials can comprise at least 10% of the total weight of the light fixture. The outer housing components formed from sustainable materials can comprise at least 40% of the total weight of the outer housing components. The flame-resistant material forming the inner housing and the sustainable material components of the outer housing can comprise at least 50% of the total weight of the light fixture. The flame-resistant material forming the inner housing and the sustainable material components of the outer housing can comprise at least 60% of the total weight of the light fixture. The flame-resistant material forming the inner housing and the sustainable material components of the outer housing can comprise at least 68% of the total weight of the light fixture. The flame-resistant material forming the inner housing and the sustainable material components of the outer housing can comprise at least 85% of the total weight of the light fixture.

Another method of manufacturing a light fixture comprises forming an inner housing from flame-resistant material to contain high-voltage components; and forming an outer housing for enclosing the inner housing, the outer housing consisting of an optical component, and components formed from sustainable material that includes at least one component that is at least one of bio-degradable and bio-renewable. The inner housing can be formed to provide a structural framework for the light fixture. The optical component may be formed from an optical quality material that may or may not be a sustainable material. The sustainable material may include at least one component that is at least one of recycled and recyclable. The at least one component that is at least one of recycled and recyclable can be recycled. The at least one component that is at least one of bio-degradable and bio-renewable can be bio-renewable.

Forming the outer housing can include selecting a sustainable material composition comprising less than 76% recyclable material and at least 24% bio-renewable material. Forming the outer housing can include selecting a sustainable material composition comprising about 70% synthetic polymer, about 26% bio-renewable filler, and about 4% natural pigment. The synthetic polymer is selected from a recycled thermoplastic material. The bio-renewable filler can be selected as about 11.5% cellulose and about 88.5% calcium carbonate. The bio-renewable filler can be selected as about 20% cellulose and about 80% calcium carbonate.

This summary is provided to introduce a selection of the concepts that are described in further detail in the detailed description and drawings contained herein. This summary is not intended to identify any primary or essential features of the subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and sub-combinations. All such useful, novel, and inventive combinations and sub-combinations are contemplated herein, it being recognized that the explicit expression of each of these combinations is unnecessary.

### BRIEF DESCRIPTION OF THE DRAWINGS

FIG. 1 shows a front, bottom perspective view of a first illustrative embodiment of a light fixture according to the present enclosure;

FIG. 2 shows the front, bottom perspective view of the first illustrative embodiment of the light fixture of FIG. 1 with a lower housing shown in an open position;

FIG. 3 shows a front, top perspective view of the first illustrative embodiment of the light fixture of FIG. 1;

FIG. 4 shows an exploded view of the first illustrative embodiment of the light fixture of FIG. 1;

FIG. 5 shows a lateral cross-sectional view of portion “5” of the first illustrative embodiment of the light fixture as shown in FIG. 3;

FIG. 6 shows a longitudinal cross-sectional view of portion “6” of the first illustrative embodiment of the light fixture as shown in FIG. 3;

FIG. 7 shows a lateral cross-sectional view of portion “7” of the first illustrative embodiment of the light fixture as shown in FIG. 3;

FIG. 8 shows a lateral cross-sectional view of portion “8” of the first illustrative embodiment of the light fixture as shown in FIG. 3, but shown with the lower housing in an open position;

FIG. 9 shows a lateral cross-sectional of a cover component of the first illustrative embodiment of the light fixture shown in FIG. 1;

FIG. 10 shows an end perspective view of a hinge component of the first illustrative embodiment of the light fixture shown in FIG. 1;

FIG. 11 shows a front, top perspective view of a central portion of the inner housing of the first illustrative embodiment of the light fixture shown in FIG. 1;

FIG. 12 shows a rear, top perspective view of a second illustrative embodiment of a light fixture according to the present enclosure;

FIG. 13 shows a lateral cross-sectional view of portion “13” of the second illustrative embodiment of the light fixture as shown in FIG. 12;

FIG. 14 shows a front, top perspective view of a central portion of the second illustrative embodiment of the light fixture of FIG. 12; and

FIG. 15 shows an illustrative method for manufacturing a light fixture according to the present disclosure.

### DETAILED DESCRIPTION

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

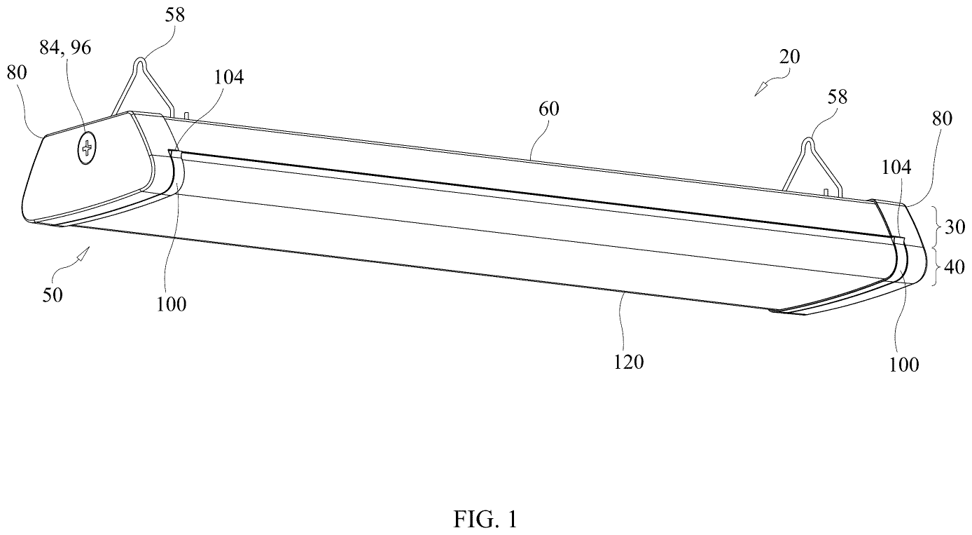

Referring to FIG. 1, a bottom, front perspective view of a first illustrative embodiment of a light fixture 20 according to the present disclosure is shown. The light fixture 20 generally takes an overall form of a type of commercial light fixture commonly known as a wrap light fixture but was developed with design criteria that emphasize the use of sustainable materials while maintaining other traditional design criteria including those discussed herein, including functionality, material integrity, cost, aesthetic, and industry safety standard requirements. An outer housing 50 encloses an inner housing 150. “Enclose” and “enclosure” are understood to mean that a housing or enclosure fully encompasses an interior space while not necessarily offering a complete seal, for example, from water ingress, and any openings therethrough are limited to those required for the passage of electrical wires, fasteners, conduit, access closures, and mounting hardware.

The outer housing 50 includes an optical component 120 and other components 60, 80, and 100 formed from sustainable materials, which may include one or more components such as bio-renewable fillers, natural textiles, biopolymers, and recycled synthetic polymer, for example a recycled thermoplastic such as polypropylene (PP). The outer housing 50 not only enhances the fixture's aesthetic appeal but also contributes to environmental sustainability by incorporating a recycled and/or recyclable component and a bio-renewable component into the sustainable material. The integration of sustainable materials of the outer housing 50 with an inner housing 150 allows the first illustrative light fixture 20 to satisfy competing design criteria, including environmental, safety, and cost standards, making it a commercially viable solution for modern lighting needs.

The sustainable material used in the first illustrative light fixture 20 has a recycled polypropylene base and a sustainable filler material such as those available from Blue Planet Biodegradable Materials (Dongguan) Co., Ltd, of Dongguan City, Guangdong Province, China. For example, the sustainable material composition can be 70% virgin or recycled plastic, 26% bio-renewable filler, and 4% natural pigment. In one embodiment the sustainable material composition is 70% recycled polypropylene, and the 26% bio-renewable filler includes 3% cellulose and 23% calcium carbonate (source from waste shells), and the 4% natural pigment is titanium dioxide. The 70% polypropylene includes trace amounts (i.e., less than 1% each) of hindered phenol antioxidants, phosphite antioxidants, and mineral oil. This sustainable material is suitable for molding, for example, injection molding. The bio-renewable fillers are also biodegradable and accelerate the breakdown and possible recycling of the other materials in the composition after decommissioning of the light fixture 40. For example, PP-LS3218-1C is a sustainable material composition available from Blue Planet Biodegradable Materials (Dongguan) Co., Ltd., and provides the desired material integrity and aesthetics, e.g., color matching, for commercial light fixtures. In another embodiment the sustainable material composition is 75% virgin or recycled plastic, 20% calcium carbonate, and 5% cellulose. Sustainable filler material that may be used includes but is not limited to bio-renewable materials such as powdered seashell (i.e. calcium carbonate), coffee chaff, hemp, paper pulp, or another bio-renewable filler used to displace some of the recycled plastic.

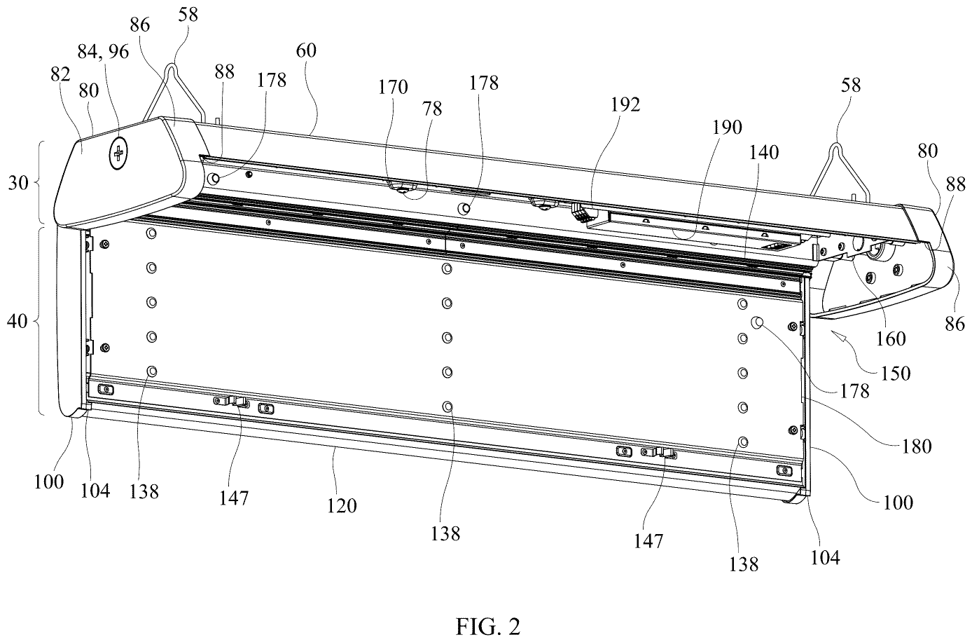

Referring now to FIG. 2, also a bottom, front perspective view, the fixture 20 also comprises an upper housing 30 and a lower housing 40. The lower housing 30 is shown in an open position relative to the upper housing 40 in FIG. 2. In the open position, the inner housing 150 of fixture 20 is visible. The inner housing 150 is formed from a flame-resistant and optionally rigid material, such as sheet metal, for example, 22-gauge galvanneal steel, to securely contain high-voltage components such as a power supply 190 and wire terminals 192 and to provide a structural chassis for the fixture. The material and configuration of the inner housing 150 is essential for meeting industry safety standards, including flame-resistance and electric shock protection, which the inventors have found sustainable materials cannot reasonably satisfy without violating other design criteria such as cost, aesthetics, and minimizing weight. Flame-resistant material and electric shock protection are understood to be as defined by applicable industry safety standards for commercial light fixtures, including UL 8750 and its references standards for LED light fixtures.

The outer housing 50 components formed from sustainable materials include a cover 60, upper end caps 80, and lower end caps 100. The upper housing 30 comprises a top portion 160 of the inner housing 150 and the cover 60 and upper end caps 80 of the outer housing. The lower housing 40 comprises the lower portion 180 of the inner housing 150 and lower end caps 100 and optical element 120. The lower housing 40 also forms an integrated optics assembly as will be discussed further below.

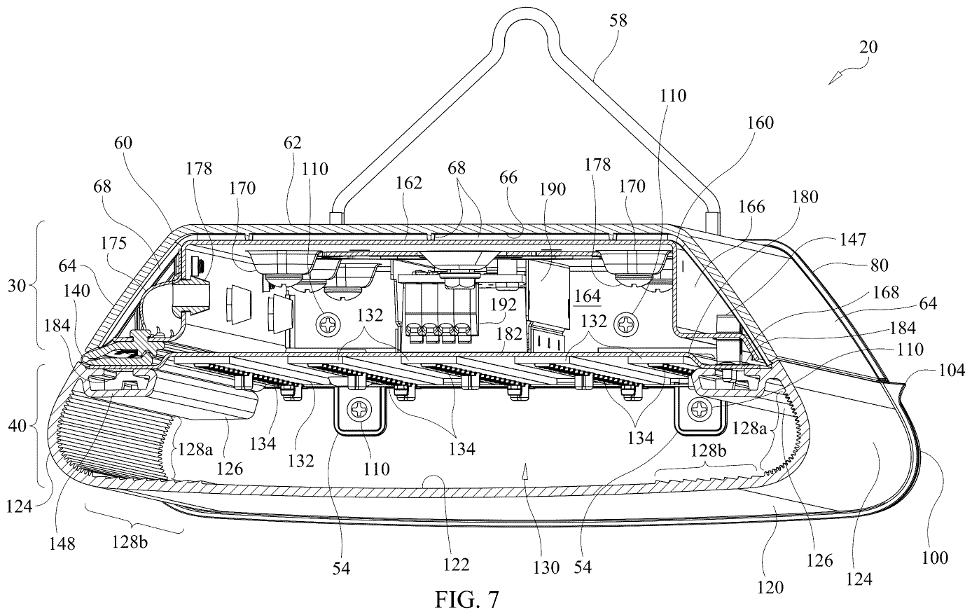

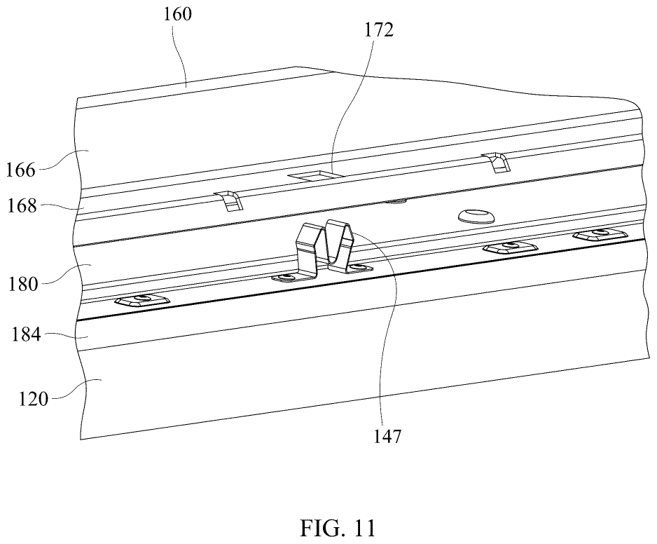

A hinge 140 couples the lower housing 40 to the upper housing 30 along one side. On an opposite side of the lower housing 40 from the hinge 140, spring clips 147 are mounted to the lower portion 180 of the inner housing 150 and engage within an opening forming a catch 172 (FIG. 11) defined by the top portion 160 of the inner housing upon the lower housing 40 being closed relative to the upper housing 30. The catches 172 retains the spring clips 147, thereby retaining the lower housing 40 in the closed position. Projecting tabs 104 defined by the lower end caps 100 provide a location to press lower housing 40 downward to overcome the resistance of the spring clips 172 in the catches 172, thereby opening the lower housing 30 for installation and decommissioning. Each upper end cap 80 on opposite ends of the upper housing 30 defines a recessed wall 88 area in the side wall 86 that is shaped to receive the corresponding lower end cap 100 located on opposite ends of the lower housing 40 upon the lower housing being closed relative to the upper housing. Additionally, the side walls 86 of the upper end caps 80 form a recess that can receive the ends of the cover 60 and top portion 160 of the inner housing 150 therein. The upper end caps 80 may be secured to the end 162 of the top portion 160, for example, using fasteners 110 (FIG. 7). Optionally, throughout the construction of the first illustrative light fixture 20, plastic fasteners/snaps that are recycled and/or recyclable can be substituted for metal fasteners typically used in commercial light fixtures.

A bore 84 defined by the upper end cap 80, for example, an NPT threaded bore, is configured to receive plug 96. The plug 96 can be removed from the upper end cap 80 for connection of a conduit to supply power, to couple power to an adjacent light fixture, or to couple a sensor or other lighting accessory to the fixture 20. Advantageously, the plugs 96 can be formed from the same sustainable material as the upper end cap 80. The hangers 59 attach through the outer housing 50 to the inner housing 150 and can be used to securely attach the fixture 20 to a ceiling or other intermediate hanging devices known in the art.

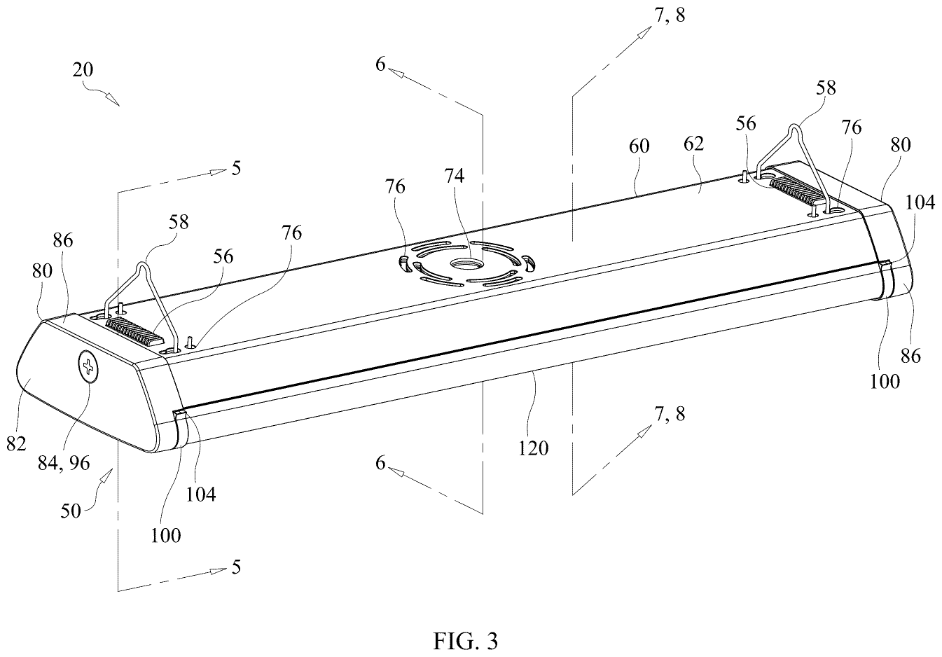

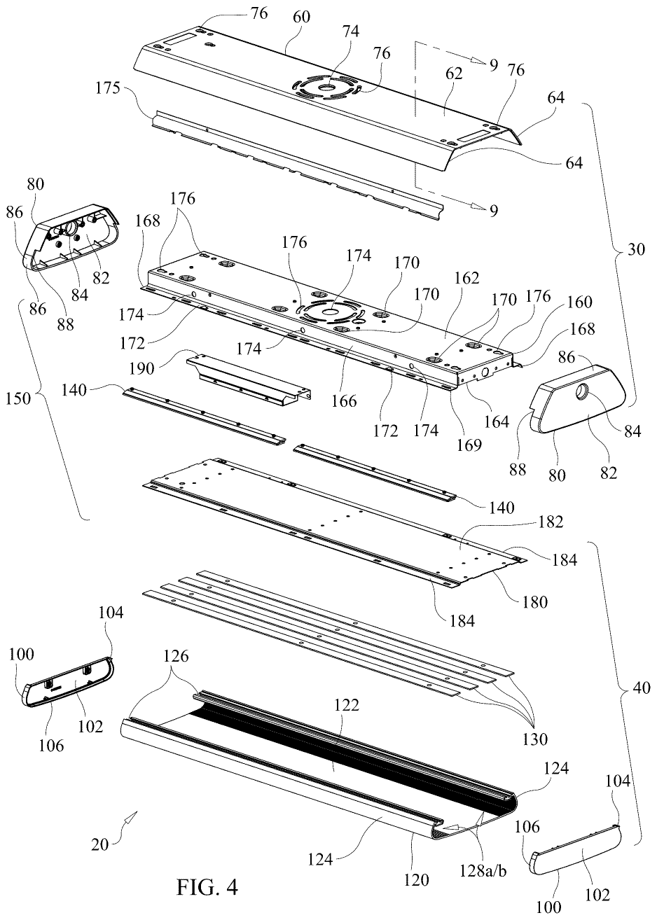

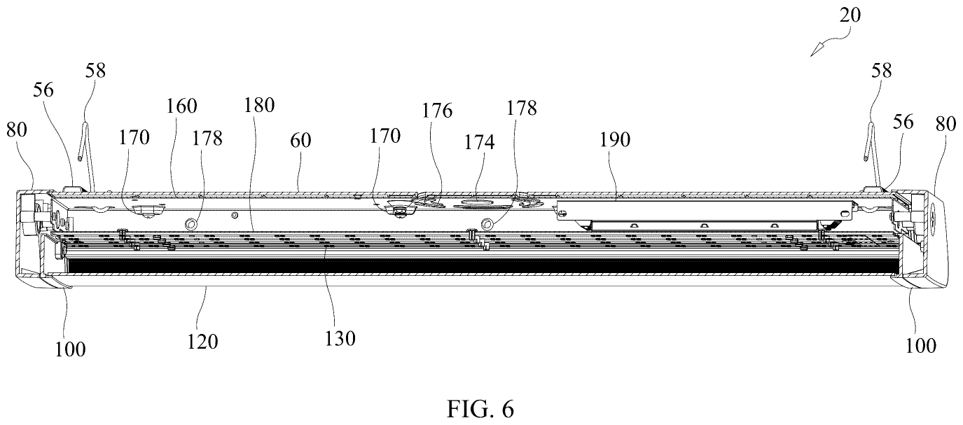

Referring now to FIG. 3, a front, top perspective view of the first embodiment of the fixture 20, various mounting features 76 are illustrated that provide clearance through a top portion 62 of the cover 60 so that fasteners or other mounting devices, including the hangers 58 and/or resilient spacers 56 can be secured to the top portion 160 of the inner housing 150 for mounting to a ceiling or other overhead suspension or structure. Additionally, a passageway 74 defined thru the top portion 62 of the cover 60 and a corresponding passageway 174 (FIGS. 4 and 6) defined thru the top portion 160 of the inner housing 150 provides a routing location for an overhead conduit for electrical power and/or for pendant mounting of the light fixture 20.

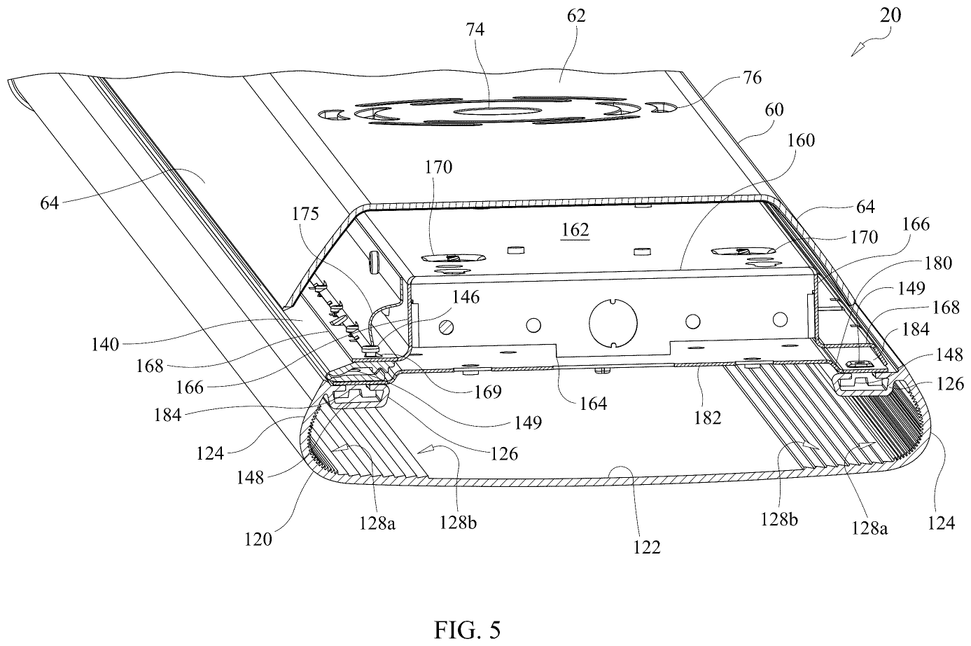

Referring now to FIGS. 4 and 5, FIG. 4 is an exploded view of the first embodiment of the light fixture 20 and FIG. 5 is a lateral sectional view near an end of the light fixture 20. FIGS. 4 and 5 illustrate the general structure and assembly of the principal components of the first illustrative light fixture 20. The inner housing 150 includes the top portion 160, a wire channel cover 175 (discussed further below), and a bottom portion 180. The inner housing encloses the power supply 190, for example, an LED driver and also an optional emergency backup battery and/or driver, including high voltage components and connections, and can be formed and configured from a material, for example galvanneal sheet steel, to satisfy industry safety standards such as UL 8750 (Light Emitting Diode (LED) Equipment for Use in Lighting Products), including flame-resistance and electric shock protection. The use of galvanneal to provide corrosion resistance is more eco-friendly and thus sustainable than the more toxic process of galvanizing steel or using powder-coating finishes.

The components of the upper housing 30 and the lower housing 40 are also evident from FIGS. 4 and 5. The upper housing 30 includes the cover 60, the upper end caps 80, and the top portion 160 of the inner housing 150. Components of the lower housing 40 include the bottom portion 180 of the inner housing 150, the lower end caps 100, and the optical component 120. The light source 130 can be mounted to an underside of central tray 182 portion of the bottom portion 180 of the inner housing 150.

The hinges 140 of the first illustrative embodiment of the light fixture 20 are of the type commonly known as living hinges in that a flexible structure rather than relative movement of components enables the rotational function between the leaves 141. Such hinges are made of a durable yet flexible material with significant challenge discovered by the inventors in incorporating into a commercial light fixture being alignment of connected components and sag or droop of the hinge 140 structure over time. In the illustrative embodiment, the hinges can be injection molded from virgin or recycled polypropylene (PP). The hinges 140, which can be a single component or multiple components (as shown), are fastened to a flange 168 along one side of the top portion 160 of the inner housing 150 and to a frame 184 along a corresponding side of the bottom portion 180 of the inner housing. Referring to FIG. 4, advantageously, channels 126 defined at opposite sides 124 of the optical component 120 can receive anchors 148 and fasteners 149 can be screwed into anchors 148 to secure a lower leaf 141 of the hinge 140 to a top of the frame 184 and the channel 126 of the optical component 120 to a bottom of the frame 184. Additionally, the channel 126 defined at the opposite side 124 of the optical component 120 can be secured to a bottom of the frame 184 on the opposite side of the bottom portion 180 of the inner housing 150 with anchors 148 and fasteners 149, thus securing the optical component 120 to the bottom portion 180 of the inner housing 150.

Referring to FIG. 10, an end perspective view of the hinge 140, the hinge includes a top and bottom leaf 141 connected by a barrel 142a defining an internal cylindrical opening 142b that defines the pivot axis for of the hinge leaves 141, allowing for rotational movement of the bottom leaf 141 relative to the top leaf 141 with the lower housing 40 is opened relative to the upper housing 30. The wall thickness 143a defined by the barrel 142a and the internal cylindrical opening 142b is substantially thinner than the wall thickness 143b and 143c of the top and bottom leaves 141. For example, in the illustrative embodiment, the wall thickness 143a of the barrel 142a is less than 20% of the wall thickness 143b and 143c of the leaves 141. For example, a wall thickness 143a approximately half of the circumference of the barrel 142a of 0.3 mm and a wall thickness 143b and 143c of leaves 141 of 1.65 mm.

Alignment elements 144a, 144b, and 144c of the hinge 140 are configured to enable precise alignment of the hinge leaves 141 as the lower housing 40 is closed, ensure the lower housing 40 is properly aligned with the upper housing 30 upon closing. In the illustrative first embodiment of the light fixture 20, the alignment features 144a-c of the hinge 140 form what is commonly known as a tongue and groove joint along the longitudinal length of the hinge. For example, the alignment feature 144a of the bottom leaf 141 forming a protrusion that is guided and centered between a pair of protrusions formed by the alignment features 144b and 144c of the top leaf 141 that are spaced and shaped to guide and center the alignment feature 144a therebetween. Ribs 145 defined by the leaves 141 and extending between the barrel 142a and the alignment features 144a and 144b provide additional reinforcement to the structure of the hinge 140, enhancing its durability and preventing drop or sag over time. Retention heads 146 formed on top leaf 141 enable the hinge 140 to be slidably received and secured in a corresponding series of keyhole slots defined by and along the length of the flange 168 (FIGS. 4 and 5) of the top portion 160 of the inner housing 150.

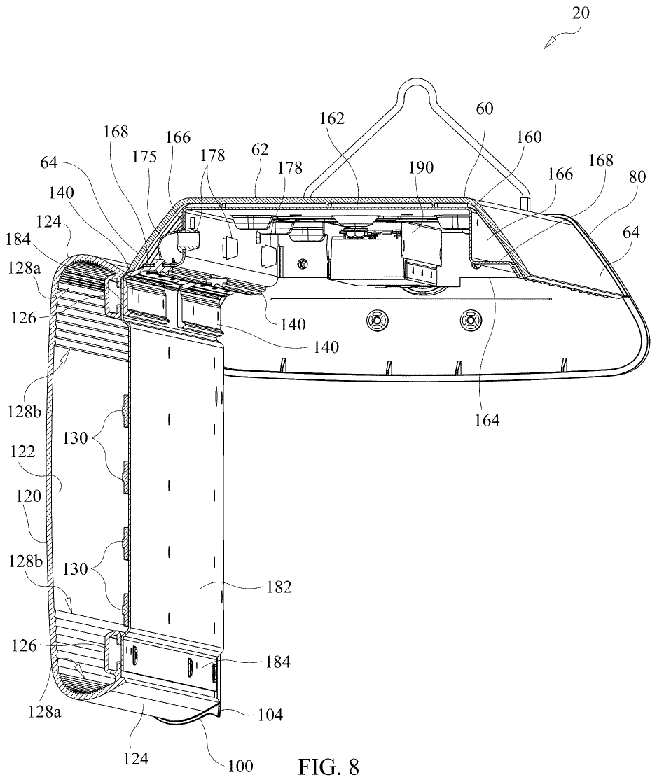

Referring now to FIGS. 6, 7, and 8 of the first illustrative light fixture 20, FIG. 6 shows a longitudinal cross-sectional view and FIGS. 7 and 8 show lateral cross-sectional views with FIG. 7 illustrating the lower housing 40 in the closed position and FIG. 8 illustrating the lower housing 40 in the open position. In the open position, the lower portion 180 of the inner housing 150 is lowered from the bottom of the top portion 160 so that the interior of the inner housing 150 is accessible for installation or decommissioning of the light fixture 20. For example, the mounting features 176 and passageway 174, are accessible from within the light fixture 20 for mounting and to feed AC or other power therethrough. Additionally, the power supply 190 and associated terminals 192 are mounted to the underside of top 162 of the top portion 160 of the inner housing 150 and are accessible when the lower housing 40 is in the open position. In contrast, and advantageously, the light source 130, for example, LED boards 132 and LEDs 134 and the interior surface of the optical component 122 remain inaccessible and closed off when the lower housing 40 is in the open position, closed off by the bottom portion 180 of the inner housing 150 and the lower end caps 100. Advantageously, wire connections connecting low voltage power from the power supply 190 to the light source 130 in the lower housing 40 can be routed thru a concealed wire channel by passing through grommets 178 (FIGS. 6 and 7) retained within passageways 174 (FIG. 4) defined thru the sides 166 of the top portion 160 of the inner housing 150. The grommets 178 protect the wires from chaffing by the metal construction of the inner housing 150.

As shown in FIG. 7, in the first illustrative light fixture 20, the concealed wire channel is more located between the cover 60 and the flange 168 and side wall 160 along one side of the top portion 160 of the inner housing 150, and is more specifically defined by the space between wire channel cover 175 and the flange 168 and side wall 160 to which it attaches. Referring briefly to FIG. 5, channel cover 175 is coupled with fasteners and/or other means of retention.

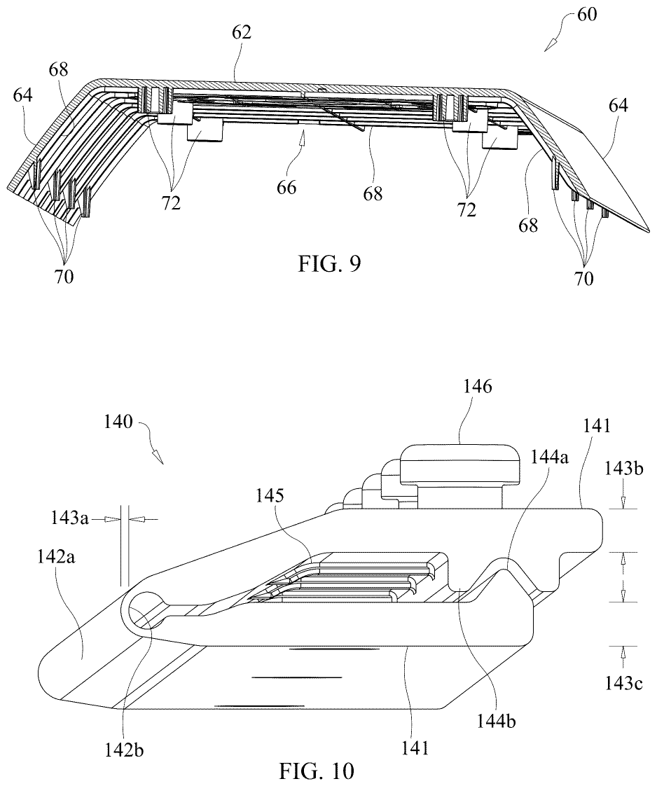

Referring to FIG. 9, a lateral cross-sectional view illustrates features of the cover 60 defined by an interior surface 66 of the cover. A top portion 62 is generally planar and side walls 64 project downward from opposite edges of the top portion 62. The top portion 62 defines bosses projecting downward from interior surface 66. The bosses 72 can provide spacing of the cover 60 from the top portion 160 of the inner housing 150 and also receiving a fastener 178 for securing the cover to the top portion 160. As shown in FIGS. 4, 6, and 7, pockets 170 defined in the top 162 of the top portion 160 of the inner housing project downward forming a receiving area for the bosses 72 of the cover 60. Fasteners 178 extend thru a base of the pockets 170 and are anchored in the bosses 72, thereby securing the cover 60 to the inner housing 150.

Still referring to FIG. 7, the cover 60 includes ribs 68 that project downward from an interior surface 66 to help maintain structural integrity and shape of the cover 60 and provide stand offs from the interior housing 150 to minimize thermal contact of the cover 60 with the top 162 of the top portion 160 and the heat generating power supply 190 mounted thereto. Minimizing thermal contact helps to ensure material integrity from heat generated from the power supply 190 and can also help ensure the first illustrative light fixture 20 meets industry safety standards. The ribs can extend longitudinally along the interior surface 66 of the cover 60 and can extend laterally across the interior surface of the side walls 64 and top portion 62. Additionally, the interior surface 66 defines projections 70 extending downwardly and outwardly therefrom that are positioned and shaped to engage into corresponding apertures or other retention features defined by flanges 168 of the interior housing 150 top portion 160, thereby stabilizing the side walls 64 relative to the top portion 160 of the inner housing 150, thus maintaining the shape and alignment of the side walls 64 of the cover 60 relative to the interior housing.

The lower housing 40 also forms an integrated optics assembly that is not disturbed when opening the lower housing 40 from the upper housing for installation or decommissioning. The optical component 120 in the first illustrative light fixture is also part of the outer housing 50 and is a lens incorporating optical elements such as prismatic elements 128a and 128b to provide a desired light distribution, thereby increasing efficiency and reducing power and structure required for the light fixture 20 to provide the desired lighting effect. The prismatic element 128a forming a first pattern and/or optical effect can cover the side 124 portions of the interior surface 122 that receive light from the light source 130 and the prismatic element 128b forming a second pattern and/or optical effect can be located on portions of the interior surface 122 adjacent the sides 124. For example, the prismatic elements 128a and 128b may be configured to provide a uniform, glare-free illumination, eliminating hot or cold spots and improving lighting aesthetics and efficiency. Advantageously, the optical component 120 is designed to be extruded from an optical quality material, for example, polycarbonate (PC), polymethyl methacrylate (PMMA), polypropylene (PP), or glass. The material the optical component 120 is formed from can be virgin or recycled and can be a recyclable material. In the illustrative embodiment of the optical component 120 is extruded from quality PMMA and an optical finish is provided. The inner surface or the outer surface of the optical component 120 can also be chemical etched or sandblasted to provide a desired texture and optical effect.

Within the lower housing 40, the light source 130 is supported above the interior surface 122 of the optical component by the tray 184 portion of the lower portion 180. The light source 130 can be LEDs 134 mounted to at least one LED board 132, which can be secured to the tray 184 by fasteners 138 (FIG. 2). The lower end caps 100 on opposite ends of the lower portion 180 and optical component 120 complete the enclosure of the integrated optics assembly, i.e. the lower housing 40. The lower end caps 100 may be coupled to the tray 184 portion of the lower portion 180 of the inner housing 150, for example with right-angle brackets 54 and fasteners 110 (FIG. 7). Advantageously, the lower end caps 100 include side walls 106 forming a recess that receives the ends of the light component 120 and lower portion 180 therein, thereby preventing light leakage or dust particle intrusion.

The following Tables 1-3 illustrate for the first illustrative light fixture 20 the comparable weight percentage of various components, including the sustainable components and the recyclable and sustainable components, that is achieved by the above described embodiment and below described process.

TABLE 1

| | Weight in | % by |
|---|---|---|
| Component | grams | weight |
| Inner Enclosure | 2560 | 53% |
| Outer housing | | |
| Cover, end caps, end cap plugs | 675 | 14% |
| Hinge | 64 | 1% |
| Optical Component | 804 | 17% |
| Driver | 240 | 5% |
| LED boards | 402 | 8% |
| Misc hardware | 115 | 2% |
| Total | 4860 | |

TABLE 2

| | Weight in | % by |
|---|---|---|
| Outer housing only | grams | weight |
| Cover, end caps, end cap plugs | 675 | 44% |
| Hinge | 64 | 4% |
| Optical Component | 804 | 52% |
| Total | 1543 | |

TABLE 3

| Recyclable metal and sustainable | Weight in | % by |
|---|---|---|
| material | grams | weight |
| Inner Housing | 2560 | 53% |
| Cover, end caps, end cap plugs | 675 | 14% |
| Hinge | 64 | 1% |
| Optical Component | 804 | 17% |
| % of Total Fixture Weight | | 85% |

Any sub-combination of the features described above and illustrated in the drawings of the first illustrative light fixture 20 may be incorporated into the second illustrative light fixture 220 described below.

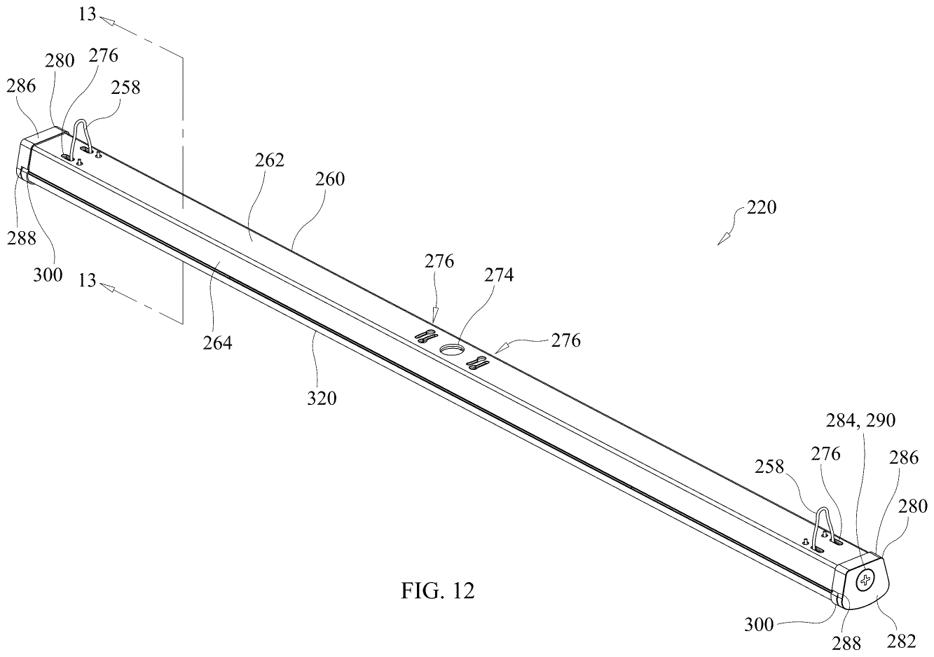

Referring to FIG. 12, a top, rear perspective view of a second illustrative embodiment of a light fixture 220 according to the present disclosure is shown. The light fixture 220 generally takes an overall form of a type of commercial light fixture commonly known as a strip light fixture but like the first illustrative light fixture 20 was also developed with design criteria that emphasize the use of sustainable materials while maintaining other traditional design criteria including those discussed herein, including functionality, material integrity, cost, aesthetic, and industry safety standard requirements. An outer housing 250 encloses an inner housing 350. The outer housing 250 includes an optical component 320 and other components 260, 280, and 300 formed from sustainable materials as discussed herein.

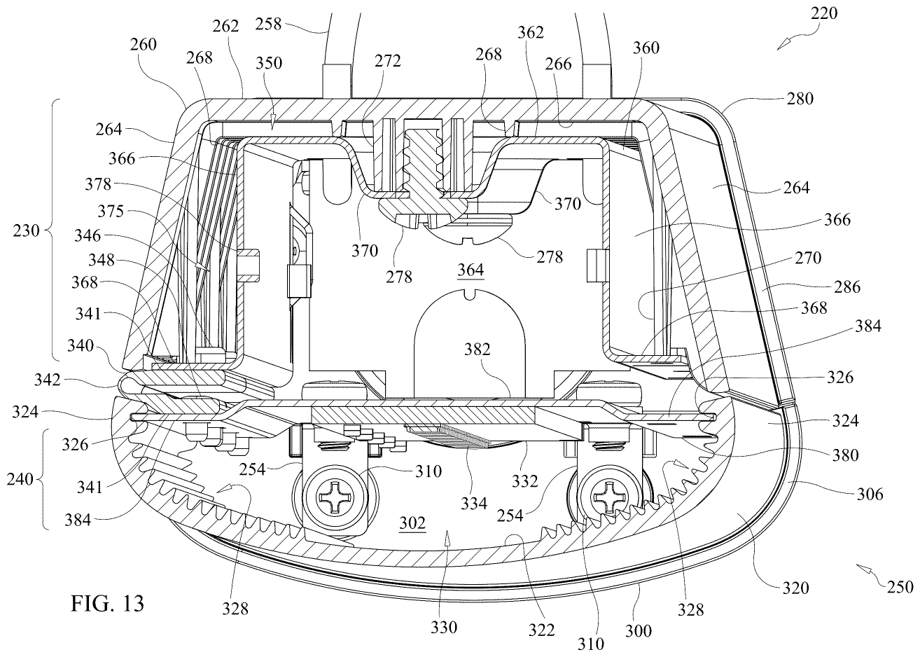

Referring now to FIG. 13, a lateral cross-sectional view, the light fixture 220 also comprises an upper housing 230 and a lower housing 240. The lower housing 230 is shown in a closed position relative to the upper housing 240, but like the first illustrative light fixture 20 is also able to be swung open from the upper housing 240 for installation and decommissioning. The inner housing 350 is formed from a flame-resistant and optionally rigid material, such as sheet metal, for example, 24-gauge galvanneal steel, to securely contain high-voltage components such as a power supply (not shown) and wire terminals (not shown) and to provide a structural chassis for the fixture. The material and configuration of the inner housing 350 is essential for meeting industry safety standards, including flame-resistance and shock protection, which the inventors have found sustainable materials cannot reasonably satisfy without violating other design criteria such as cost, aesthetics, and minimizing weight.

The outer housing 250 components formed from sustainable materials include a cover 260, upper end caps 280, and lower end caps 300. The upper housing 230 comprises a top portion 360 of the inner housing 350 and the cover 260 and upper end caps 280 of the outer housing. The lower housing 240 comprises the lower portion 380 of the inner housing 350 and lower end caps 300 and optical element 320. The lower housing 240 also forms an integrated optics assembly as will be discussed further below.

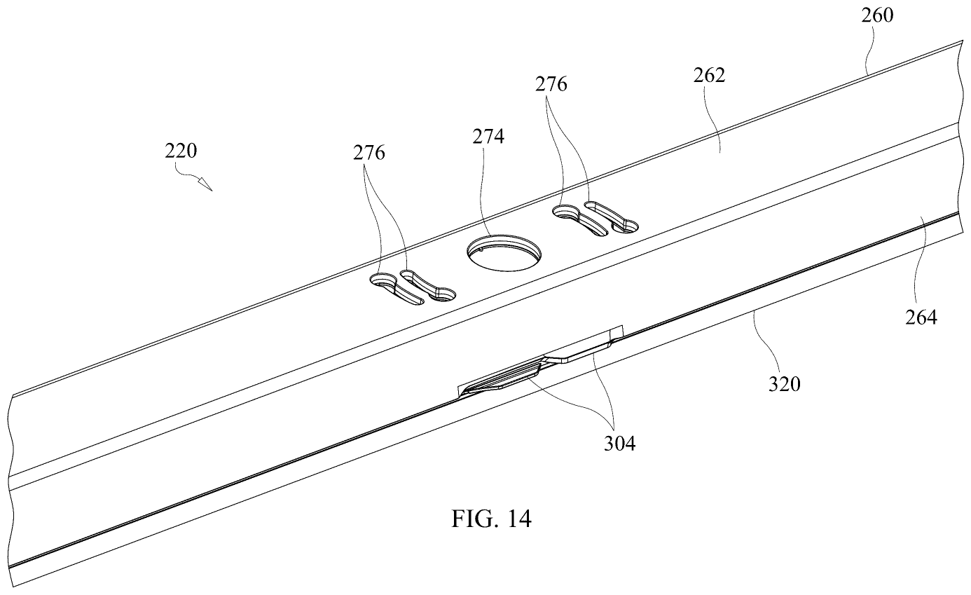

A hinge 340 couples the lower housing 240 to the upper housing 230 along one side. On an opposite side of the lower housing 240 from the hinge 340, spring clips (not shown) are mounted to the lower portion 380 of the inner housing 350 and engage within an opening forming a catch (not shown) defined by the top portion 360 of the inner housing upon the lower housing 240 being closed relative to the upper housing 230. The catches retain the spring clips, thereby retaining the lower housing 240 in the closed position. Referring to FIG. 14, projecting tabs 304 defined by the side wall 264 of the cover 260 and by the bottom portion 380 of the inner housing 350 provide a means of pressing lower housing 240 downward away from the upper housing 250 to overcome the resistance of the spring clips in the catches, thereby opening the lower housing 240 for installation and decommissioning.

Referring again to FIG. 12, each upper end cap 280 on opposite ends of the upper housing 230 defines a recessed wall 288 area in the side wall 286 that is shaped to receive the corresponding lower end cap 300 located on opposite ends of the lower housing 240 upon the lower housing being closed relative to the upper housing. Additionally, the side walls 286 of the upper end caps 280 form a recess that can receive the ends of the cover 260 and top portion 360 of the inner housing 350 therein. A bore 284 defined by the upper end cap 280, for example, an NPT threaded bore, is configured to receive plug 296. The plug 296 can be removed from the upper end cap 280 for connection of a conduit to supply power, to couple power to an adjacent light fixture, or to couple a sensor or other lighting accessory to the fixture 220. Advantageously, the plugs 296 can be formed from the same sustainable material as the upper end cap 280. The hangers 258 attach through the outer housing 250 to the inner housing 350 and can be used to securely attach the fixture 220 to a ceiling or other intermediate hanging devices known in the art.

Various mounting features 276 are illustrated that provide clearance through a top portion 262 of the cover 260 so that fasteners or other mounting devices, including the hangers 258 and/or resilient spacers (not shown) can be secured to the top portion 360 of the inner housing 350 for mounting to a ceiling or other overhead suspension or structure. Additionally, a passageway 274 defined thru the top portion 262 of the cover 260 and a corresponding passageway (not shown) defined thru the top portion 360 of the inner housing 350 provides a routing location for an overhead conduit for electrical power and/or for pendant mounting of the light fixture 220.

Referring again to FIG. 13, the inner housing 150 includes the top portion 360 and a bottom portion 380. The inner housing encloses the power supply (not shown), for example an LED driver also an optional emergency backup battery and/or driver, including high voltage components and connections, and can be formed and configured from a material, for example galvanneal sheet steel, to satisfy industry safety standards such as UL 8750, including flame-resistance and high voltage shock protection. The upper housing 230 includes the cover 260, the upper end caps 280, and the top portion 360 of the inner housing 350. Components of the lower housing 240 include the bottom portion 380 of the inner housing 350, the lower end caps 300, and the optical component 320. The light source 330 can be mounted to an underside of central tray 382 portion of the bottom portion 380 of the inner housing 350.

The hinges 340 of the second illustrative embodiment of the light fixture 220 are of the type commonly known as living hinges in that a flexible structure rather than relative movement of components enables the rotational function between the leaves 341. Such hinges are made of a durable yet flexible material with significant challenge discovered by the inventors in incorporating into a commercial light fixture being alignment of connected components and sag or droop of the hinge 340 structure over time. In the illustrative embodiment, the hinges can be injection molded from virgin or recycled polypropylene (PP). The hinges 340, which can be a single component or multiple components (as shown), are fastened to a flange 368 along one side of the top portion 360 of the inner housing 350 and to a frame 384 along a corresponding side of the bottom portion 380 of the inner housing, for example, using fasteners 348.

The hinge 340 includes a top and bottom leaf 341 connected by a barrel 342 defining an internal cylindrical opening that defines the pivot axis for of the hinge leaves 341, allowing for rotational movement of the bottom leaf 341 relative to the top leaf 341 with the lower housing 240 is opened relative to the upper housing 230. The wall thickness defined by the barrel 342 and the internal cylindrical opening is substantially thinner than a wall thickness of the top and bottom leaves 341. For example, in the illustrative embodiment, the wall thickness of the barrel 142 is less than 20% of the wall thickness of the leaves 341. For example, a wall thickness 143a of approximately half of the circumference of the barrel 142a of 0.26 mm and a wall thickness 143b and 143c of leaves 141 of 1.4 mm. Retention heads 346 formed on top leaf 341 enable the hinge 340 to be slidably received and secured in a corresponding series of keyhole slots (not shown) defined by and along the length of the flange 368 of the top portion 360 of the inner housing 350.

Advantageously, wire connections connecting low voltage power from the power supply (not shown) to the light source 330 in the lower housing 240 can be routed thru a concealed wire channel by passing through grommets 378 retained within passageways defined thru the sides 366 of the top portion 360 of the inner housing 350. The grommets 378 protect the wires from chaffing by the metal construction of the inner housing 350. The concealed wire channel is formed by the space defined between the cover 260 and the flange 368 and side wall 360 along one side of the top portion 360 of the inner housing 350.

A top portion 262 of the cover 260 is generally planar and side walls 264 project downward from opposite edges of the top portion 262. The top portion 262 defines bosses 272 projecting

downward from interior surface 266. The bosses 272 can provide spacing of the cover 260 from the top portion 260 of the inner housing 250 and also receiving a fastener 278 for securing the cover to the top portion 360. Pockets 370 defined in the top 362 of the top portion 360 of the inner housing project downward forming a receiving area for the bosses 272 of the cover 360. Fasteners 278 extend thru a base of the pockets 370 and are anchored in the bosses 272, thereby securing the cover 260 to the inner housing 350.

The cover 260 includes ribs 268 that project downward from an interior surface 266 to help maintain structural integrity and shape of the cover 260 and provide stand offs from the interior housing 350 to minimize thermal contact of the cover 260 with the top 362 of the top portion 360 and the heat generating power supply mounted thereto. Minimizing thermal contact helps to ensure material integrity from heat generated from the power supply, such as an LED driver, and can also help ensure the second illustrative light fixture 220 meets industry safety standards. The ribs can extend longitudinally along the interior surface 266 of the cover 260 and can extend laterally across the interior surface of the side walls 264 and top portion 262. Additionally, the interior surface 266 defines projections 270 extending downwardly and outwardly therefrom that are positioned and shaped to engage into corresponding apertures (not shown) or other retention features defined by flanges 368 of the interior housing 350 top portion 360, thereby stabilizing the side walls 264 relative to the top portion 360 of the inner housing 350, thus maintaining the shape and alignment of the side walls 264 of the cover 260 relative to the interior housing.

The lower housing 240 also forms an integrated optics assembly that is not disturbed when opening the lower housing 240 from the upper housing for installation or decommissioning. The optical component 320 in the second illustrative light fixture 220 is also part of the outer housing 250 and is a lens incorporating optical elements such as prismatic elements 328, for example, across and adjacent to sides 324 of the optical component, to provide a desired light distribution, thereby increasing efficiency and reducing power and structure required for the light fixture 220 to provide the desired lighting effect. For example, the prismatic elements 328 may be configured to provide a uniform, glare-free illumination, eliminating hot or cold spots and improving lighting aesthetics and efficiency. Advantageously, the optical component 320 is designed to be extruded from an optical quality material, for example, polycarbonate (PC), polymethyl methacrylate (PMMA), polypropylene (PP), or glass. The material the optical component 320 is formed from can be virgin or recycled and can be a recyclable material. In the illustrative embodiment of the optical component 320 is extruded from UGR quality PMMA or PP and an optical finish is provided. The outer surface of the optical component 320 can also be chemical etched or bead blasted to provide a desired texture and optical effect. Advantageously, channels 326 defined at opposite sides 324 of the optical component 320 can receive a corresponding edge of the flange 384 of the bottom portion 380 of the inner housing 350, thus securing the optical component 320 to the bottom portion 380 of the inner housing 350.

Within the lower housing 240, the light source 330 is supported above the interior surface 322 of the optical component by the tray 384 portion of the lower portion 380. The light source 330 can be LEDs 334 mounted to at least one LED board 332, which can be secured to the tray 384 by fasteners (not shown). The lower end caps 300 on opposite ends of the lower portion 380 and optical component 320 complete the enclosure of the integrated optics assembly, i.e. the lower housing 240. Referring to FIG. 12, the lower end caps 300 may be coupled to the tray 384 portion of the lower portion 380 of the inner housing 350, for example with right-angle brackets 254 and fasteners 310. Advantageously, the lower end caps 300 include side walls 306 forming a recess that receives the ends of the light component 320 and lower portion 380 therein, thereby preventing light leakage or dust particle intrusion.

The following Tables 4-6 illustrate for the second illustrative light fixture 220 the comparable weight percentage of various components, including the sustainable components and the recyclable and sustainable components, that is achieved by the above described embodiment and below described process.

TABLE 4

| | Weight in | % by |
|---|---|---|
| Component | grams | weight |
| Inner Housing | 1062 | 48% |
| Outer housing | | |
| Cover, end caps, end cap plugs | 219 | 10% |
| Hinge | 36 | 2% |
| Optical Component | 180 | 8% |
| Driver | 614 | 28% |
| LED boards | 72 | 3% |
| Misc hardware | 17 | 1% |
| Total | 2200 | |

TABLE 5

| | Weight in | % by |
|---|---|---|
| Outer housing only | grams | weight |
| Cover, end caps, end cap plugs | 219 | 50% |
| Hinge | 36 | 8% |
| Optical Component | 180 | 41% |
| Total | 435 | |

TABLE 6

| Recyclable metal and sustainable | Weight in | % by |
|---|---|---|
| material | grams | weight |
| Inner Housing | 1062 | 48% |
| Cover, end caps, end cap plugs | 219 | 10% |
| Hinge | 36 | 2% |
| Optical Component | 180 | 8% |
| % of total fixture weight | | 68% |

Any sub-combination of the features described above and illustrated in the drawings of the second illustrative light fixture 220 may be incorporated into the first illustrative light fixture 20 described further above. Additionally or alternatively, any sub-combination of the features described above and illustrated in the drawings of the first and second light fixtures 20 and 220 may be incorporated into the method 1500 described below.

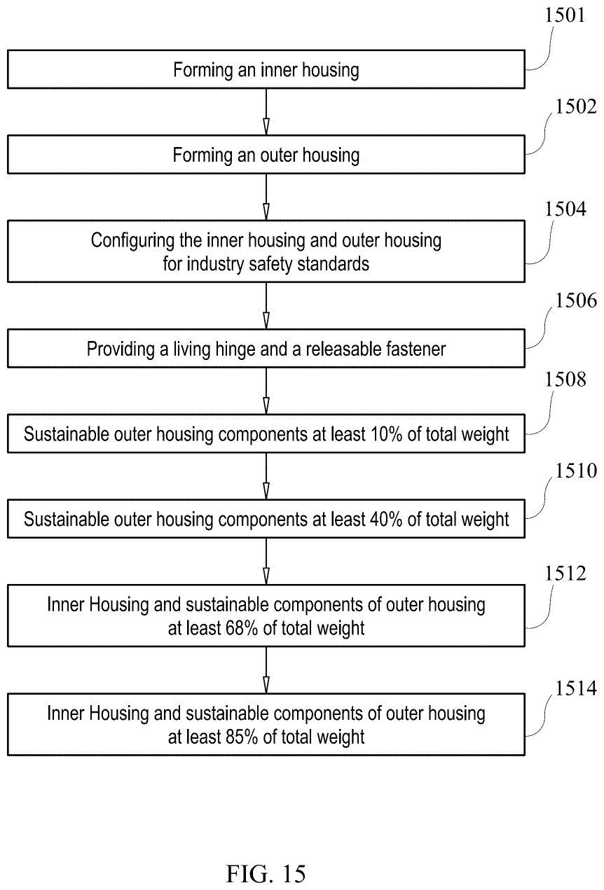

FIG. 15 is a flowchart illustrating a method 1500 for manufacturing a light fixture, according to the present disclosure. At step 1501, the method may begin with forming an inner housing from a flame-resistant material. The inner housing encloses high voltage components and optionally provides a structural framework for the light fixture. The inner housing may be formed from rigid material, for example, galvanneal sheet metal, which may enable compliance with safety standards such as UL 8750 for LED light fixtures. The use of galvanneal to provide corrosion resistance is more eco-friendly and thus sustainable than the more toxic process of galvanizing steel or using powder-coating finishes. The inner housing may also be configured to support the outer housing and define attachment features for mounting the light fixture.

In step 1502, the method includes forming an outer housing designed to enclose the inner housing. This outer housing may consist of an optical component and components formed from sustainable materials. The sustainable material may include at least one component that is bio-degradable and bio-renewable. The sustainable material may include at least at least one component that is recycled and recyclable. The at least one component that is recycled and recyclable and at least one component that is bio-degradable and bio-renewable may be the same component. The selection of a sustainable material composition may include bio-renewable fillers, natural textiles, biomass-sourced textiles, and biopolymers. The sustainable material composition may be selected to comprise less than 76% recyclable material and at least 24% bio-renewable material. Additionally, the composition may include about 70% synthetic polymer, about 26% bio-renewable filler, and about 4% natural pigment. The synthetic polymer selected may be a recycled thermoplastic material, while the bio-renewable filler may be composed of about 11.5% cellulose and about 88.5% calcium carbonate, or alternatively, about 20% cellulose and about 80% calcium carbonate. About is understood to be defined as with the range of plus or minus 2.5 percentage points of a stated percentage. Optionally, in the construction of the light fixture according to this method, plastic fasteners/snaps that are recycled and/or recyclable can be substituted for metal fasteners typically used in commercial light fixtures.

In step 1504, the method includes configuring the inner housing and outer housing to enable the light fixture to meet flame-resistance and high voltage industry safety standards. The inner housing may be formed from rigid sheet metal, which can provide the necessary structural framework and enable safety for high-voltage components, flame resistance, and adhering to industry safety standards. The configuration may include organizing wiring and concealing wires and high voltage connections from users, including providing electrical shock protection by configure the structure to prevent fingers from reaching high voltage areas and ensuring openings are too small for fingers to extend into and contact high voltage areas, for example a minimum diameter of less than 12 mm.

In step 1506, the method includes providing a living hinge that attaches one edge of a top portion of the inner housing to a corresponding edge of a bottom portion of the inner housing. Additionally, a fastener may be provided to releasably attach the other edge of the bottom portion of the inner housing to the top portion of the inner housing, thereby enabling the opening and closing functionality of the light fixture. This configuration may allow for ease of access to the internal components, such as the power supply and the bottom side of the top portion of the inner housing for installation and decommissioning. The step 1506 may include selecting a recycled and/or recyclable material for the living hinge, for example, polypropylene (PP). The step 1506 may also include mounting the power supply to the bottom side of the top portion of the inner housing and mounting a light source to the bottom side of the bottom portion of the inner housing, thus providing access to connect the power supply to AC power, but limiting access to the light source located within the lower portion of the housing.

Additionally, or alternatively, in step 1508, the outer housing components of the light fixture may be formed from sustainable materials selected and configured to comprise at least 10% of the total weight of the light fixture. This step may involve the strategic selection and integration of materials that are recycled and/or recyclable, as well as bio-degradable and/or bio-renewable, to ensure that the environmental impact of the light fixture is minimized. The sustainable materials used in the outer housing may include a variety of compositions, such as bio-renewable fillers, natural textiles, biomass sourced textiles, and biopolymers, which may be selected to meet specific design and functional criteria. The outer housing may also include optical components, such as lenses or diffusers, which may be formed from materials like polycarbonate, polymethyl methacrylate, polypropylene, or glass, to provide the necessary optical functionality while maintaining the sustainable design criteria.

Additionally or alternatively, in step 1510, the outer housing components are formed from sustainable materials selected and configured to comprise at least 40% of the total weight of the outer housing components. This step may involve the selection and integration of materials that are both recycled and recyclable, as well as bio-degradable and bio-renewable, to ensure that the outer housing aligns with environmental sustainability goals, and may include any of the above and below described features discussed to achieve the sustainable material weight parameter.

Additionally or alternatively, in step 1512, the flame-resistant material forming the inner housing and the sustainable material components of the outer housing are selected and configured to comprise at least 50% of the total weight of the light fixture, or alternatively at least 60% of the total weight of the light fixture, or alternatively at least 68% of the total weight of the light fixture. This step may involve the use of a metal interior housing, which may be recycled and/or recyclable metal and may be configured to contain high-voltage components, provide a structural framework for the light fixture, and provide flame-resistance to enable safety and compliance with industry safety standards. Using recycled material for the inner housing also reduced the environmental impact of manufacturing and decommissioning of the light fixture. The outer housing may consist of components formed from sustainable materials, which may include those described herein including a mixture of organic materials mixed with a virgin or recycled thermoplastic plastic. Thus, this step may involve the selection and integration of materials that are both recycled and recyclable, as well as bio-degradable and bio-renewable, to ensure that the outer housing aligns with environmental sustainability goals, and may include any of the above and below described features and steps discussed to achieve the material weight parameter.

In step 1514, the flame-resistant material forming the inner housing and the sustainable material components of the outer housing are selected and configured to comprise at least 85% of the total weight of the light fixture. Thus, this step may involve the selection and integration of materials that are both recycled and recyclable, as well as bio-degradable and bio-renewable, to ensure that the outer housing aligns with environmental sustainability goals, and may include any of the above described features and steps discussed to achieve the material weight parameter.

Any sub-combination of the features discussed above and illustrated in the drawings of the method 1500 may be incorporated into the first and second illustrative embodiments 20 and 220 described further above.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

What is claimed is:

1. A light fixture comprising:
an inner housing configured to contain high-voltage components and form a structural framework for the light fixture, wherein the inner housing is formed from a flame-resistant material; and
an outer housing enclosing the inner housing, wherein the outer housing consists of an optical component, and components formed from a sustainable material that includes at least one component that is at least one of recycled and recyclable and at least one component that is at least one of bio-degradable and bio-renewable.

2. The light fixture of claim 1, wherein the at least one component that is at least one of recycled and recyclable is recycled and the at least one component that is at least one of bio-degradable and bio-renewable is bio-renewable.

3. The light fixture of claim 2, wherein the flame-resistant material forming the inner housing is rigid metal.

4. The light fixture of claim 3, wherein the sustainable material comprises at least one of bio-renewable fillers, natural textiles, biomass sourced textiles, and biopolymers.

5. The light fixture of claim 1, wherein the at least one component that is at least one of recycled and recyclable and the at least one component that is at least one of bio-degradable and bio-renewable is the same component.

6. The light fixture of claim 1, wherein the sustainable material is formed from a composition comprising less than 76% recyclable material and at least 24% bio-renewable material.

7. The light fixture of claim 1, wherein the sustainable material comprises about 70% synthetic polymer, about 26% bio-renewable filler, and about 4% natural pigment.

8. The light fixture of claim 7, wherein the synthetic polymer is a recycled thermoplastic material.

9. The light fixture of claim 7, wherein the bio-renewable filler composition comprises about 11.5% cellulose and about 88.5% calcium carbonate.

10. The light fixture of claim 7, wherein the bio-renewable filler composition comprises about 20% cellulose and about 80% calcium carbonate.

11. The light fixture of claim 1, wherein the optical component includes at least one of a lens and a diffuser formed from one of polycarbonate, polymethyl methacrylate, polypropylene, and glass.

12. The light fixture of claim 1, wherein the outer housing components formed from the sustainable material comprises a cover and a plurality of end caps.

13. The light fixture of claim 12, wherein the cover defines bosses configured for spacing and attachment of the cover to the inner housing, ribs configured for shape retention, and protrusions configured for retaining portions of the cover in alignment with the inner housing.

14. The light fixture of claim 1, further comprising a hinge coupling one side of an upper housing and a lower housing of the light fixture.

15. The light fixture of claim 14, wherein the hinge is a living hinge and includes alignment features defined on opposite leaves of the hinge.

16. The light fixture of claim 15, wherein the alignment features form a tongue and groove joint.

17. The light fixture of claim 15, wherein a barrel portion of the hinge defines a substantially thinner wall thickness than a wall thickness of the leaves of the hinge.

18. The light fixture of claim 17, wherein the hinge defines ribs extending between the barrel portion and the alignment features.

19. The light fixture of claim 14, further comprising at least one of a spring clip and a magnet for releasably retaining the lower housing in a closed position relative to the upper housing.

20. The light fixture of claim 14, wherein the upper housing includes a top portion of the inner housing and the lower housing includes a bottom portion of the inner housing.

21. The light fixture of claim 14, wherein the upper housing includes a cover, top end caps, at least one power supply, and a top portion of the inner housing.

22. The light fixture of claim 14, wherein the lower housing includes an optical subassembly including a lens, lower end caps, a combined light emitter tray and lens frame forming a bottom portion of the inner housing, and light emitter boards coupled to a bottom side of the bottom portion of the inner housing.

23. The light fixture of claim 1, wherein the inner housing is configured to enable the light fixture to meet flame-resistance and high voltage industry safety standards.

24. The light fixture of claim 23, wherein the inner housing is configured to support the outer housing and defines attachment features for mounting the light fixture.

25. The light fixture of claim 23, wherein the inner housing defines between the inner housing and the outer housing at least one wire channel for routing wires through, thereby limiting visibility of and access to the wires from the space between a top portion and a bottom portion of the inner housing.

26. The light fixture of claim 23, wherein any openings defined through the inner housing adjacent exposed high voltage terminals and connections have a minimum diameter of less than 12 millimeters.

27. The light fixture of claim 1, wherein the outer housing components formed from sustainable materials comprise at least 10% of the total weight of the light fixture.

28. The light fixture of claim 1, wherein the outer housing components formed from sustainable materials comprise at least 40% of the total weight of the outer housing components.

29. The light fixture of claim 1, wherein the flame-resistant material forming the inner housing and the sustainable material components of the outer housing comprise at least 68% of the total weight of the light fixture.

30. The light fixture of claim 1, wherein the flame-resistant material forming the inner housing and the sustainable material components of the outer housing comprise at least 85% of the total weight of the light fixture.

31. A light fixture comprising:
an inner housing configured to contain high-voltage components, wherein the inner housing is formed from a flame-resistant material; and
an outer housing enclosing the inner housing, wherein the outer housing consists of an optical component, and components formed from sustainable material that includes at least one component that is at least one of bio-degradable and bio-renewable.

32. The light fixture of claim 31, wherein:
the flame-resistant material is rigid; and
the inner housing forms a structural framework for the light fixture.

33. The light fixture of claim 32, wherein the flame-resistant material forming the inner housing and the sustainable material components of the outer housing comprise at least 50% of the total weight of the light fixture.

34. The light fixture of claim 31, wherein the sustainable material further includes at least one component that is at least one of recycled and recyclable.

35. The light fixture of claim 33, wherein: the at least one component that is at least one of recycled and recyclable is recycled.

36. The light fixture of claim 33, wherein the at least one component that is at least one of bio-degradable and bio-renewable is bio-renewable.

37. The light fixture of claim 33, wherein:
the at least one component that is at least one of recycled and recyclable is recycled; and
the at least one component that is at least one of bio-degradable and bio-renewable is bio-renewable.

38. The light fixture of claim 31, wherein the sustainable material is formed from a composition comprising less than 76% recyclable material and at least 24% bio-renewable material.

39. The light fixture of claim 31, wherein the sustainable material comprises about 70% recycled thermoplastic, about 26% bio-renewable filler, and about 4% natural pigment.
